(19) United States
(12) Patent Application Publication
(10) Pub. No.: US 2006/0132604 A1
(43) Pub. Date: Jun. 22, 2006

(54) Video quick zoom and autofocus for officer safety

(76) Inventors: Ich-Kien Lao, Raleigh, NC (US); William Bradford Slivernail, Raleigh, NC (US); Randy Grey Martinez, Burlington, NC (US); Albert J. Dalola, Cary, NC (US)

Correspondence Address: JOHN L. SOTOMAYOR, 511 DAVIS DRIVE, SUITE 300, MORRISVILLE, NC, 27560, US

(21) Appl. No.: 11/332,319

(22) Filed: Jan. 17, 2006

Related U.S. Application Data
(63) Continuation-in-part of application No. 10/703,258, filed on Nov. 7, 2003.
(60) Provisional application No. 60/319,676, filed on Nov. 8, 2002.

(51) Int. Cl. H04N 7/18; H04N 3/28; H04N 5/228

(52) U.S. Cl. 348/148; 348/208.14; 348/206

(57) ABSTRACT

This invention automatically captures an image of an object, such as a vehicle or license plate, in the view of a camera mounted in a vehicle, such as a police car, without requiring any action upon the part of the driver of the vehicle containing the camera. The camera also adjusts for poor weather conditions and low light conditions, capturing a sharp image stored for later review and use. This invention is particularly useful for police officers during traffic stops, allowing the officer to concentrate upon the stopped vehicle rather than splitting attention between the vehicle and the video capture, providing the officer with a safer experience in the performance of their duties.

### PRIORITY

This application is a Continuation-in-Part of U.S. Non-Provisional patent application Ser. No. 10/703,258 filed Nov. 7, 2003 and is herein incorporated by reference, which claims priority to U.S. Provisional Application Ser. No. 60/319,676, filed Nov. 8, 2002.

### BACKGROUND OF THE INVENTION

A variety of conventional mobile and vehicle-installed video systems, utilizing both analog and digital methodologies, have been developed in recent years to assist law-enforcement agencies in the collection of evidence during law enforcement activities. Such activities include traffic stops, arrests, surveillance, and the like. The collection of evidence is one aspect of the installed system utilized by law-enforcement officers to perform their duties. However, these installed systems may also be utilized to provide for greater safety for law-enforcement officers during such activities, as well as greater clarity on the video record which is later used as evidence.

During the execution of a law enforcement event the most dangerous part of the activity, such as a traffic stop, is just as the law enforcement officer must exit the car. At this point, the law enforcement officer must divide attention between the occupants of the stopped vehicle and the vehicle itself to record such information as the vehicle license plate number. In addition, if the activity occurs at night, low light levels and light scattering from the reflective coating on a license plate reduce visibility to the point that the captured video images, as recorded by the officer, may be useless for evidentiary purposes.

Providing a means by which the law enforcement officer does not have to divide his/her attention increases the officer's safety. If an officer is injured or killed in the line of duty during a traffic stop prior to issuing a citation, the video record of the license plate may be the only clue as to who the officer stopped. In addition, mitigating low-light and light-scattering circumstances without any action or intervention on the part of the law-enforcement officer increases the confidence of such law-enforcement officials that their evidentiary assertions will be corroborated by a high-quality video record of the events in question.

The present invention provides an elegant solution to the problems of providing for the safety of law-enforcement officers and increasing the clarity of the video record for evidentiary purposes.

### SUMMARY OF THE INVENTION

The present invention provides an effective and efficient method for automatically improving image quality gathered by a video camera used in a mobile environment without the intervention of an individual who is commanding the mobile environment. The video camera image adjustment is set such that upon receipt of a trigger event, the video camera automatically adjusts focus for distance and shutter speed to capture a video record of events in front of the mobile environment. The captured video data is stored in an onboard high-capacity storage device, such as a hard drive, solid state memory, flash memory, etc., and later transferred to a home base data repository for archival, retrieval, analysis, and evidentiary use.

The trigger event is a physical action that initiates the video camera focus and shutter timing adjustment under computer program control, allowing the individual commanding the mobile environment to focus their attention on the occupants of another vehicle instead of the vehicle itself. Once the focus has been redirected, the video camera adjusts for adverse ambient light conditions to record video images of an object, such as a license plate, at which the video camera is directed. A software module under computer control further starts a time when a trigger event occurs. The timer is set to be long enough to allow the full adjustment of the video camera and provide for additional data recording after the video camera adjustment is completed. At the expiration of the timer computer program control returns the video camera focus and shutter timing to their original state and the video imagery is tagged with a metadata identifier and stored in a high-capacity on-board storage device.

The invention also includes a software module that uploads the captured video record using either a wired connection or using wireless means to transfer the data from the mobile high-capacity on-board storage device to a data storage and retrieval server.

### BRIEF DESCRIPTION OF THE DRAWINGS

The above objects and advantages of the present invention will become more apparent by describing in detail preferred embodiments thereof with reference to the attached drawings, in which:

FIG. 1 illustrates a system level diagram of a process flow of the preferred embodiment

FIG. 2 presents a process flow for daytime mode recording

FIG. 3 presents a process flow for night time mode recording

FIG. 4 presents a video snapshot of a night traffic stop as the patrol officer stops behind the vehicle that has been pulled over

FIG. 5 presents a video snapshot of the night traffic stop after the camera has zoomed

FIG. 6 presents a video snapshot of the night traffic stop after a first increase in shutter speed

FIG. 7 presents a video snapshot of the night traffic stop after a second increase in shutter speed and autofocus

FIG. 8 presents a video snapshot of the night traffic stop after the focus has returned to normal focus and shutter speed

### DETAILED DESCRIPTION

The present invention provides for increased officer security and a clearer video record for evidence purposes. The present invention can be deployed on police, fire, and rescue vehicles and is adaptable for use on mass transit vehicles. The present invention is not limited to these applications, and may be used in any environment in which a mobile surveillance system is desired.

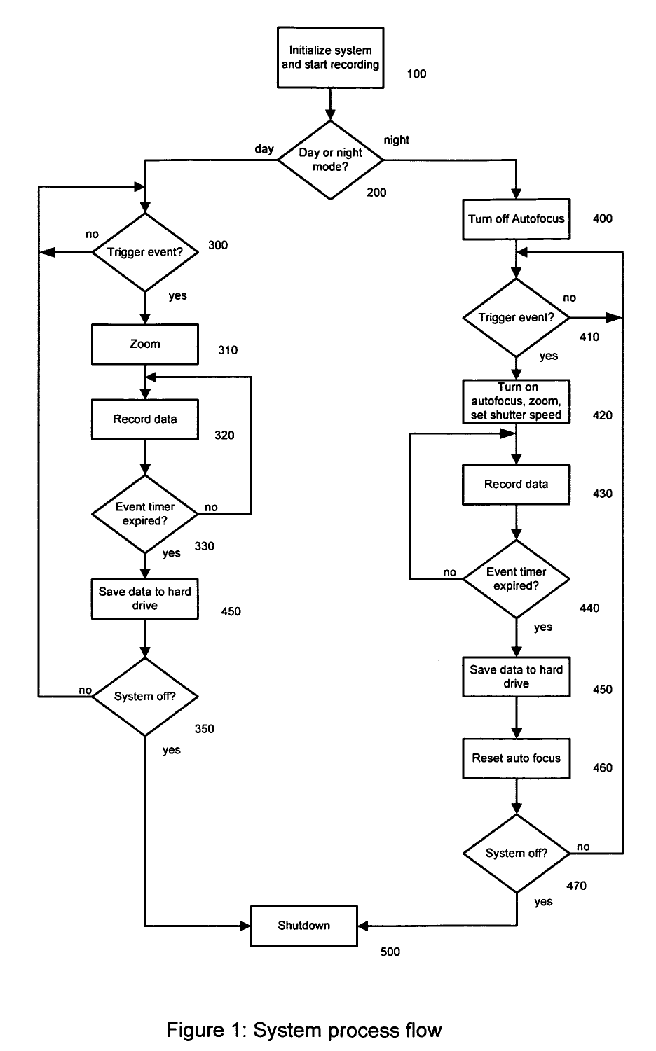

FIG. 1 describes a preferred embodiment in which the system is deployed in a mobile environment consisting of a police vehicle, which serves as the mobile platform. The embodiment disclosed herein is used by the police vehicle to collect a video record of the license plate of a vehicle that has been pulled over in a routine traffic stop.

The system is initialized and placed in continuous record mode 100 when the vehicle engine is started. Based upon ambient light conditions, the system is placed in day or night recording mode 200. In either mode, upon ordering a vehicle to the side of the road, the police vehicle stops a judicious distance, typically half a car length, behind the vehicle that has been ordered to stop.

The focal length distance for the camera zoom function is set to be from the stopped patrol car to the back of the vehicle that has been ordered to stop. This focal length distance is preset based upon a determined average distance between vehicles for such a traffic stop activity. However, the patrol officer may manually preset the focal length distance to be either shorter or longer based upon the officer's preferred stopping distance for such a traffic stop activity.

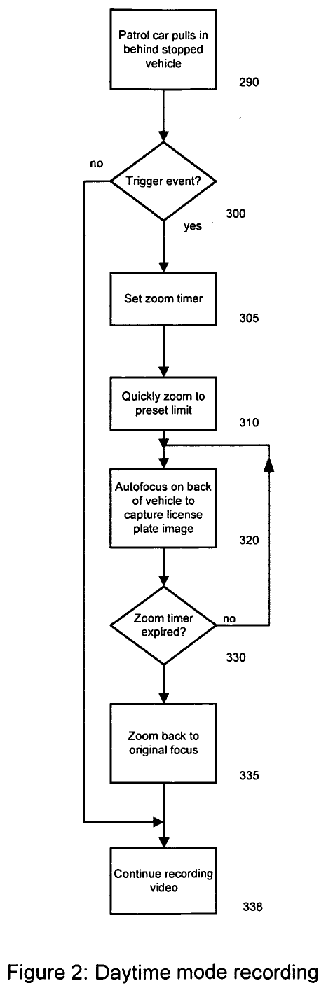

FIG. 2 describes the daytime mode process flow in which video recording begins automatically upon detection of a trigger event 300. The video camera is set in auto focus when recording is present and while awaiting a trigger event. Trigger events are preassigned in the system and include system functions such as, for example, activating a microphone, activating a siren, or other specified patrol functions. In the preferred embodiment, the trigger event is the first time an officer opens the driver side door of the police vehicle after the vehicle comes to a stop. This action also triggers a computer program module to set a trigger event timer 305. Subsequent door opening activities during the same stop activity will not trigger the zoom function. Once the trigger event occurs 300, the video camera zoom activates to focus on the back of the stopped vehicle 310 to capture a focused image of the license plate attached to the back of the stopped vehicle 320. After a preset time period, a configurable time span typically between 2 and 10 seconds, the video camera refocuses back to its original setting 335. No action by the officer is necessary, allowing the officer to maintain focus on the occupants of the stopped vehicle.

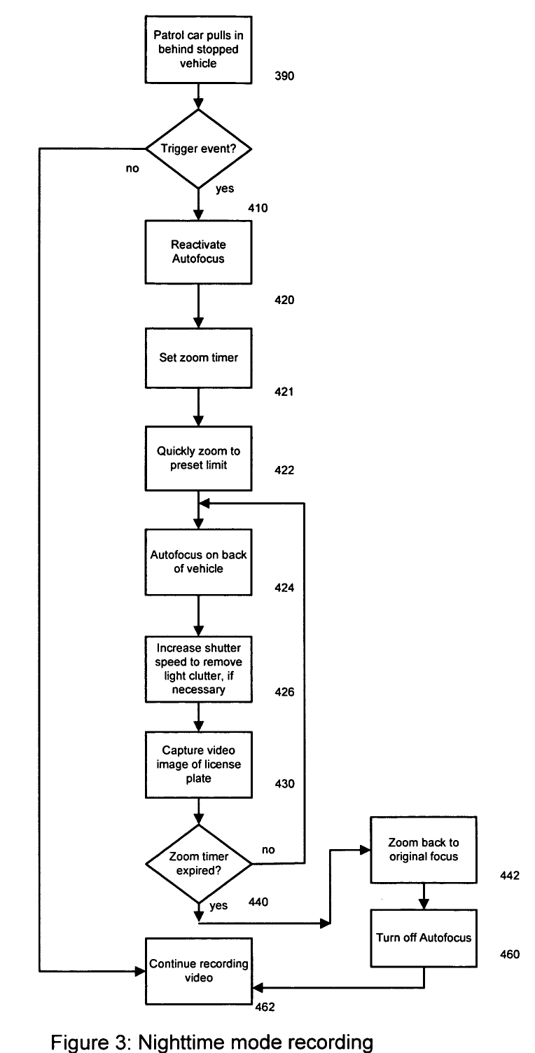

FIG. 3 describes the night time mode process flow in which the video camera is set in night mode until a trigger event occurs. Night mode is distinguished from day mode in that the auto focus feature of the video camera is turned off. This allows the video camera to maintain an even focus without searching for a better focus based upon the contrast lighting of items within the field of view of the video camera.

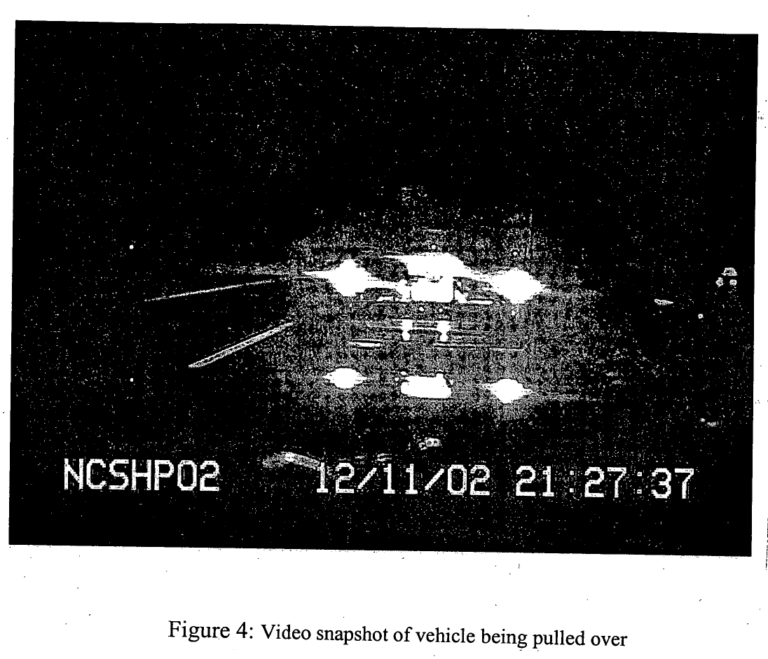

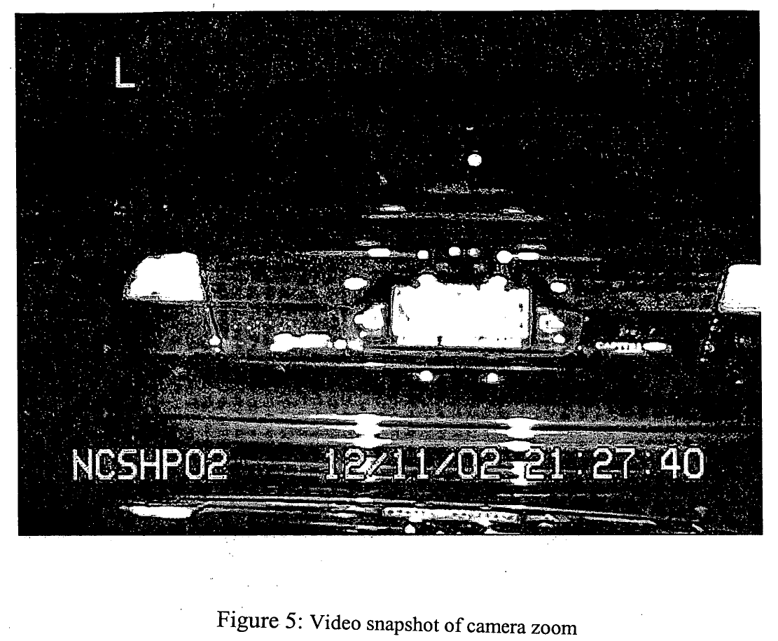

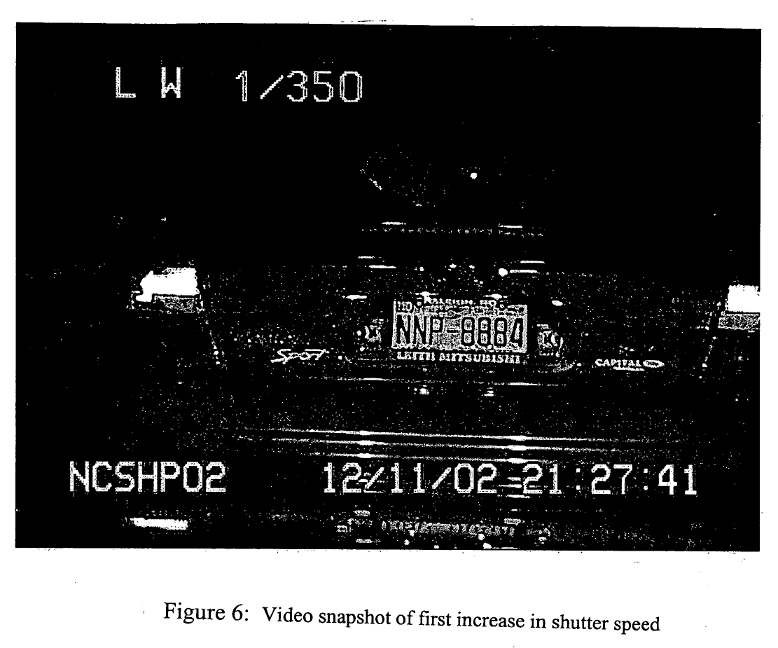

In the preferred embodiment as described above, the trigger event 410 is the first time the driver side door of the police vehicle is opened during a stop activity (FIG. 4). Once the trigger event 410 occurs, the video camera zoom activates 424 to focus on the back of the stopped vehicle FIG. 5). At the same time, auto focus is automatically reactivated 420 to allow the video camera to focus on the back of the stopped vehicle FIG. 6) and on the license plate attached to the back of the stopped vehicle. This action also triggers a computer program module to set a trigger event timer configured to control the length of time the camera is in zoom mode 421.

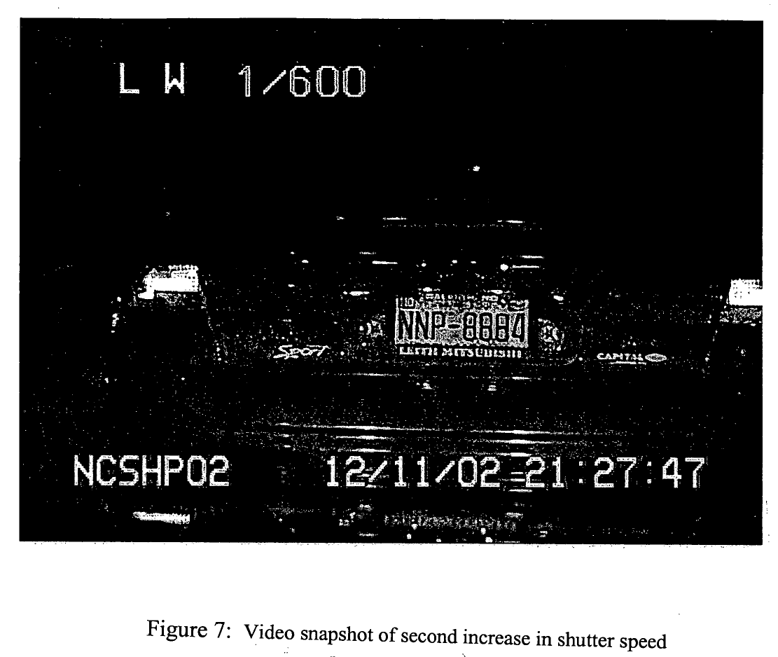

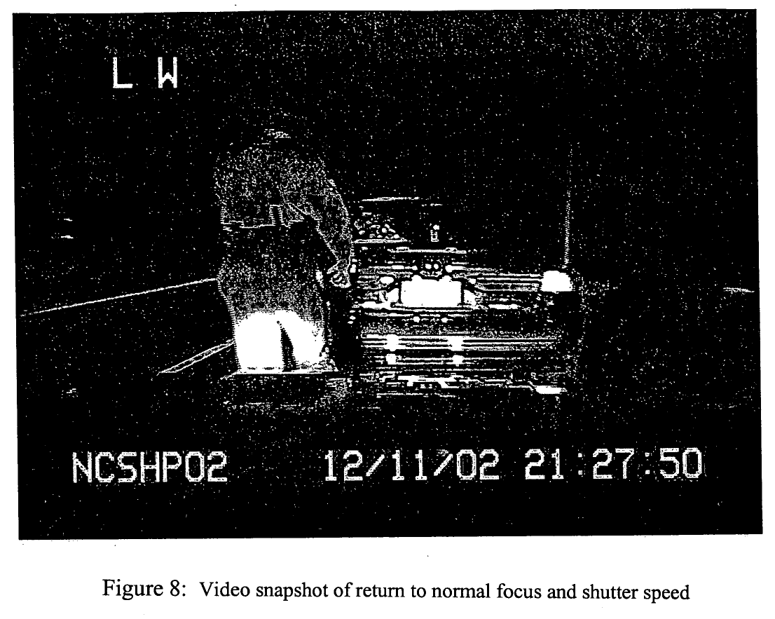

At night, light from various nighttime sources including the headlights of the patrol vehicle is scattered from the highly reflective surface of the license plate, obscuring the details of the license plate from view in the video record FIG. 4). To overcome this reflective light scattering, a system software module instructs the electronically activated shutter speed control to increase the shutter speed of the video camera 426. The faster shutter speed cuts the time the shutter is open and increases the detail of the image as less of the obscuring scattered light is collected. Other aspects of automatic exposure control, such as Iris or Aperture controls, in the video camera are permitted to operate normally. The auto focus then has the ability to focus the image at the higher shutter speed. The invention has the ability to increase the shutter speed 426 in three successive increments to allow the auto focus function to produce a crisp image of the license plate despite the poor lighting conditions FIG. 7). Once again, no action by the officer is necessary, allowing the officer to maintain focus on the occupants of the stopped vehicle FIG. 8).

After a preset time period 440, a configurable time span typically between 2 and 10 seconds, the video camera refocuses back to its original setting 442, turns the auto focus function off once again 460, and resets the video camera into night mode.

The output from the video camera is saved in an on-board high-capacity storage (HCS) device as a set of files that are referenced as a single event.

Moving saved data files from the on-board HCS to an exterior high-capacity storage system is accomplished when the patrol vehicle stops at a facility equipped with a download server and high-capacity storage equipment. This transfer is accomplished in one of two methods; (1) physically removing the on-board HCS from the mass transit vehicle and (2) transmitting the saved data files from the on-board HCS to the server over wired or wireless data communication means.

The advantages of the invention are readily apparent to one of ordinary skill in the art in that a patrol officer or emergency worker does not need to divert attention from the individual(s) within a stopped vehicle in order to provide a video image of an informational nature that can assist said officer or emergency worker in performance of their duties, while also reducing the risk to said officer or emergency worker caused by diverting his/her attention.

This innovation may also be utilized on mass transit vehicles, such as a city bus, train, or school bus, to gather information at night that is of importance to the operator of said mass transit vehicle without diverting their attention. For example, a mass transit vehicle could set a trigger event as the opening of either the front or back passenger doors and when the door opened a video camera positioned to record video of that opening would capture higher precision, night time video of vehicles in proximity to the doorways, or even passengers exiting or entering the mass transit vehicle.

While this invention has been particularly shown and described with reference to the preferred embodiment thereof, it will be understood by those skilled in the art that various changes in form and details may be made therein without departing from the spirit and scope of the invention as defined by the appended claims.

We claim:

1. A video record and image control system installed within a vehicle comprising:
a video recording device with lens and aperture controls;
a processor electrically connected to said video recording device;
a memory electrically connected to said processor configured to store a captured data stream from said video recording device;
software modules stored within said processor and configured to establish and monitor at least one timer and at least one timing period;
software modules stored within said processor and configured to initiate and control lens and aperture activity;
wherein said system is configured to control said video recording device to perform video data capture and to increase the clarity and definition of captured video data during a user definable time period without intervention from the driver of said vehicle.

2. A video record and image control system installed within a vehicle as recited in claim 1 and further comprising:
said electrical connection between said video recording device and said processor configured to establish a communication and control pathway between the two devices.

3. A video record and image control system installed within a vehicle as recited in claim 1 and further comprising:
said memory device comprising a high capacity data storage device.

4. A video record and image control system installed within a vehicle as recited in claim 1 and further comprising:
software means for setting a timer upon the occurance of a trigger event, said timer time period being user definable.

5. A video record and image control system installed within a vehicle as recited in claim 1 and further comprising:
software means for controlling lens and aperture controls of a video recording device to adjust to pre-set device parameters.

6. A process for capturing video image data through the use of video recording and image control equipment installed within a vehicle comprising the steps of:
i. initialize a video capture device to begin the capture of video data at a first level of video resolution;
ii. cause the video capture device to operate in daytime mode or nighttime mode as defined in a software control module;
iii. upon the receipt of a trigger event, as pre-defined in said software control module, initialize a trigger event timer and initiate the process of automatic video data capture at a second level of video resolution under either of daytime or nighttime mode rules under software program control;
iv. upon the expiration of a pre-defined time limit, reset the capture of video data to said first level of video resolution;
v. store all captured video data to a high capacity data storage device within the vehicle;
vi. upon receipt of any subsequent trigger event, repeat steps iii through v;
vii. wherein the automatic video data capture occurs without intervention of a driver of said vehicle eliminating distraction for said driver and providing for greater driver safety with no loss of video image data.

7. A process for capturing video image data through the use of video recording and image control equipment installed within a vehicle as recited in claim 6 and further comprising the steps of:
i. said second level of video resolution is more precise and provides a clearer video image than said first level of video resolution.

8. A process for capturing video image data through the use of video recording and image control equipment installed within a vehicle as recited in claim 6 and further comprising the steps of:
i. daytime mode is pre-defined as brighter ambient light conditions, such as during daytime;
ii. when operating in daytime mode, a software control module causes the video device lens to perform a zoom function to record video data at said second level of video resolution upon receipt of a trigger event.

9. A process for capturing video image data through the use of video recording and image control equipment installed within a vehicle as recited in claim 6 and further comprising the steps of:
i. nighttime mode is pre-defined as darker ambient light conditions, such as during night time or during weather conditions that adversely affect visibility such as, for example, fog or heavy rain;
ii. when operating in nighttime mode, a software control module is operative to cause the video recording device to perform operational steps comprising:
a. turning off the autofocus control within the video recording device;
b. upon the receipt of a trigger event, turning the autofocus control within said video recording device on;
c. causing said video recording device to perform a zoom function to record video data at said second level of video resolution;
d. causing said video recording device to perform a shutter speed control adjustment to record video data at a third level of video resolution, where said third level of video resolution provides a clearer video image than said second level of video resolution;
e. causing said video recording device to perform a subsequent shutter speed control adjustment to record video data at a fourth level of video resolution, where said fourth level of video resolution provides a clearer video image than said third level of video resolution;
f. upon expiration of said trigger event timer, turning the autofocus control of said video recording device off under software program control;
iii. Wherein the nighttime mode steps produce video data imagery at a plurality of video resolution levels to counteract low ambient light levels, and light scattering from surfaces, to produce clear images of desired objects such as, for example, a license plate on a stopped vehicle.
